(19) United States
(12) Patent Application Publication
(10) Pub. No.: US 2007/0280876 A1
(43) Pub. Date: Dec. 6, 2007

(54) Functionalization of Carbon Nanotubes in Acidic Media

(75) Inventors: James M. Tour, Houston, TX (US); Jared L. Hudson, Houston, TX (US); Christopher R. Dyke, Humble, TX (US); Jason J. Stephenson, McLean, VA (US)

Correspondence Address: WINSTEAD PC, P.O. BOX 50784, DALLAS, TX, 75201, US

(73) Assignee: William Marsh Rice University, Houston, TX (US)

(21) Appl. No.: 10/593,918

(22) PCT Filed: Mar. 24, 2005
(86) PCT No.: PCT/US05/09677

§ 371 Date: Aug. 6, 2007

Related U.S. Application Data
(60) Provisional application No. 60/556,250, filed on Mar. 25, 2004.

(51) Int. Cl. C01B 31/02

(52) U.S. Cl. 423/460

(57) ABSTRACT

The present invention is generally directed to methods of functionalizing carbon nanotubes (CNTs) in acidic media. By first dispersing CNTs in an acidic medium, bundled CNTs can be separated as individual CNTs, affording exposure of the CNT sidewalls, and thereby facilitating the functionalization of such CNTs, wherein functional groups are attached to the subsequently exposed sidewalls of these individualized CNTs. Once dispersed in this substantially unhundled state, the CNTs are functionalized according to one or more of a variety of functionalization processes. Typically, ultrasonication or non-covalent wrapping is not needed to afford such dispersion and subsequent functionalization. Additionally, such methods are easily scalable and can provide for sidewall-functionalized CNTs in large, industrial-scale quantities.

### CROSS-REFERENCE TO RELATED APPLICATIONS

This Application claims priority to U.S. Provisional Application Ser. No. 60/556,250, filed Mar. 25, 2004.

This invention was made with support from the National Science Foundation, Grant Number DMR-0073046; the Air Force Office of Scientific Research, Grant Number F49620-01-1-0364; the National Aeronautics and Space Administration, Grant Numbers JSC-NCC-9-77 and URETI NCC-01-0203; and the Office of Naval Research, Grant Number N00014-02-1-0752.

### FIELD OF THE INVENTION

This invention relates generally to carbon nanotubes, and specifically to methods of functionalizing carbon nanotubes in acidic media.

### BACKGROUND OF THE INVENTION

Carbon nanotubes (CNTs, aka fullerene pipes) are nanoscale carbon structures comprising graphene sheets conceptually rolled up on themselves and closed at their ends by fullerene caps. Single-walled carbon nanotubes (SWNTs) comprise but a single such graphene cylinder, while multi-walled nanotubes are made of two or more concentric graphene layers nested one within another in a manner analogous to that of a Russian nesting doll. Since their initial preparation in 1993 (Iijima et al., Nature, 1993, 363, 603; Bethune et al., Nature, 1993, 363, 605; Endo et al., Phys. Chem. Solids, 1993, 54, 1841), SWNTs have been studied extensively due to their unique mechanical, optical, electronic, and other properties. For example, the remarkable tensile strength of SWNTs has resulted in their use in reinforced fibers and polymer nanocomposites (Zhu et al., Nano Lett. 2003, 3, 1107 and references therein). For other existing and potential applications of CNTs, see Baughman et al., Science, 2002, 297, 787-792.

SWNTs normally self-assemble into aggregates or bundles (sometimes called “ropes”) in which up to several hundred tubes are held together by van der Waals forces. For many applications, including electronic, bio-medical, and structural composite ones, the separation of individual nanotubes from these bundles is essential (Dyke et al., J. Phys. Chem. A, 2005, 108, 11151-11159). Such separation improves the dispersion and solubilization of the nanotubes in the common organic solvents and/or water needed for their processing and manipulation. Covalent modifications of the SWNT surface generally help to solve this problem by improving the solubility/suspendability and processability of the nanotubes. While such chemical functionalizations of the nanotube ends generally do not change the electronic and bulk properties of these materials, sidewall functionalizations do significantly alter the intrinsic properties of the nanotubes (Chen et al., Science, 1998, 282, 95-98; Mickelson et al., Chem. Phys. Lett., 1998, 296, 188-194) and typically have a more profound impact on their solubility/suspendability (Boul et al., Chem. Phys. Lett., 1999, 310, 367-372). However, the extent of documented results in this new field of chemistry is limited, largely due to the current high cost of the nanotubes.

Additional challenges faced in the modifications of SWNT sidewalls are related to their relatively poor reactivity—largely due to a much lower curvature of the nanotube walls relative to the more reactive fullerenes (M. S. Dresselhaus, G. Dresselhaus, P. C. Eklund, Science of Fullerenes and Carbon Nanotubes, Academic Press, San Diego, 1996), and to the growing strain within the tubular structure with increasing number and size of functional groups attached to graphene walls. The sp²-bonding states of all the carbon atoms comprising the nanotube framework facilitate the predominant occurrence of addition-type reactions. The best characterized examples of these reactions include additions to the SWNTs of nitrenes, azomethine ylides and aryl radicals generated from diazonium salts. See V. N. Khabashesku, J. L. Margrave, Chemistry of Carbon Nanotubes in Encyclopedia of Nanoscience and Nanotechnology, Ed. H. S. Nalwa, American Scientific Publishers, 2004; Bahr et al., J. Mater. Chem., 2002, 12, 1952; and Holzinger et al., Angew. Chem. Int. Ed., 2001, 40, 4002.

The diameter and chirality of individual CNTs are described by integers “n” and “m,” where (n,m) is a vector along a graphene sheet that is conceptually rolled up to form a tube. When |n−m|=3q, where q is a non-zero integer, the CNT is a semi-metal (bandgaps on the order of milli eV). When n−m=0, the CNT is metallic-like and referred to as an “armchair” nanotube with a 0 eV bandgap. All other combinations of n−m are semiconducting CNTs with bandgaps typically in the range of 0.3 to 1.0 eV, with HiPco-derived SWNTs, being of smaller diameter, having larger bandgaps for the semiconductors in the 0.8-1.4 eV range. See O'Connell et al., Science, 2002, 297, 593. CNT “type,” as used herein, refers to such electronic types described by the (n,m) vector (i.e., metallic, semi-metallic, and semiconducting). CNT “species,” as used herein, refers to CNTs with discrete (n,m) values. CNT “composition,” as used herein, refers to make up of a CNT population in terms of nanotube type and species.

All known CNT preparative methods lead to polydisperse CNT populations of semiconducting, seminmetallic, and metallic electronic types. See M. S. Dresselhaus, G. Dresselhaus, P. C. Eklund, Science of Fullerenes and Carbon Nanotubes, Academic Press, San Diego, 1996; Bronikowski et al., Journal of Vacuum Science & Technology 2001, 19, 1800-1805; R. Saito, G. Dresselhaus, M. S. Dresselhaus, Physical Properties of Carbon Nanotubes, Imperial College Press, London, 1998. As such, another primary hurdle to the widespread application of CNTs, and SWNTs in particular, is their manipulation according to electronic structure (Avouris, Acc. Chem. Res. 2002, 35, 1026-1034). Recently, however, methods to selectively functionalize CNTs based on their electronic structure (i.e., electronic type) have been reported (Strano et al., Science, 2003, 301, 1519-1522; commonly assigned co-pending International Patent Application PCT/US04/24507, filed Jul. 29, 2004). In such reports, metallic CNTs are seen to react preferentially with diazonium species, permitting a separation or fractionation of metallic (including semimetallic) and semiconducting CNTs via partial functionalization of a mixture of metallic and semiconducting CNTs. For a detailed discussion of CNT types and species, and their optical identification, see Bachilo et al., Science, 2002, 298, 2361-2366; and Weisman et al., Nano. Lett., 2003, 3, 1235-1238.

Despite such above-described advances in chemically derivatizing the sidewalls of carbon nanotubes, most such processes require ultrasonication of the carbon nanotubes during the derivatization process in order to break up the nanotube bundles and expose the nanotube sidewalls to functionalizing agents. This sonication is difficult to scale to bulk quantities and can potentially damage many of the nanotubes in the sample. Additionally, most methods employing such sonication still have considerable difficulty providing individual nanotubes (i.e., single nanotubes not associated with a bundle in the solvent). Thus, a scaleable method of derivatizing carbon nanotubes under gentler conditions would be very beneficial, particularly if it is capable of providing individual nanotubes in their functionalized state—without the need for industrially-prohibitive or impractical procedures such as sonication, non-covalent polymer wrapping, and centrifugation.

### BRIEF DESCRIPTION OF THE INVENTION

The present invention is generally directed to methods of functionalizing (aka derivatizing) carbon nanotubes (CNTs) in acidic media. By first dispersing CNTs in an acidic medium, bundled CNTs can be separated as individual CNTs, affording exposure of the CNT sidewalls, and thereby facilitating the functionalization of such CNTs, wherein functional groups are covalently attached to the subsequently exposed sidewalls of these individualized CNTs. Once dispersed in this substantially unbundled state, the CNTs are functionalized according to one or more of a variety of functionalization processes. Typically, ultrasonication is not needed to afford such dispersion and subsequent functionalization. Additionally, such methods are easily scalable and can provide for sidewall-functionalized CNTs in large, industrial-scale quantities.

In some embodiments, the present invention is generally directed to methods of functionalizing CNTs in acidic media, such methods generally comprising the steps of: (a) dispersing CNTs in an acidic medium to form dispersed CNTs with substantially exposed sidewalls; and (b) functionalizing the dispersed CNTs by covalently attaching functional groups to their substantially exposed sidewalls to yield sidewall functionalized CNTs. For a bundle of CNTs, substantially exposed sidewalls, as defined herein, refers to a level of debundling or exfoliation sufficient to allow functionalizing agents access to nanotube sidewalls within the bundle interior. Such carbon nanotubes are generally selected from the group consisting of single-wall carbon nanotubes, double-wall carbon nanoutbes, multi-wall carbon nanotubes, small diameter carbon nanotubes, and combinations thereof

In such above-described embodiments, the acidic medium generally comprises any acid medium suitable for facilitating the debundling of CNTs (i.e., rendering the sidewalls of CNTs accessible to functionalizing agents), and which is compatible with one or more desired functionalization protocols. In some embodiments, the acidic medium comprises a superacid. While not intending to be bound by theory, it is believed that in superacids (and possibly other acids), CNTs are surrounded by a double layer of protons and counterions. See Davis et al., Macromolecules, 2004, 37, 154. It is likely that this proposed intercalation of ions is at least partially responsible for the dubundling of the CNTs.

In such above-described embodiments, the step of functionalizing generally involves a functionalizing agent selected from the group consisting of carbocations, halonium ions, metal cations, carbon radicals, halogen radicals, hetero-atom radical species, metal-based radicals, dipolarophiles, and combinations thereof In some embodiments, the step of functionalizing involves a diazonium species. Such diazonium species can be generated in situ by reaction of an aniline species with a nitrite species, or via a diazonium salt.

Some of the above-described embodiments further comprise at least one post-processing step directed at the functionalized CNTs and selected from the group consisting of diluting, filtering, washing, drying, resuspending, and combinations thereof For example, the above-described embodiments may further comprise the steps of (a) isolating the sidewall functionalized carbon nanotubes from the acidic medium by filtering to yield isolated sidewall functionalized carbon nanotubes; and (b) resuspending the isolated sidewall functionalized carbon nanotubes in a solvent. Depending on the functional moieties attached to the CNT sidewall, such resuspending can be done in a variety of aqueous or organic solvents (including superacid solvents).

The foregoing has outlined rather broadly the features of the present invention in order that the detailed description of the invention that follows may be better understood Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 (Scheme 1) schematically illustrates embodiments of the present invention where SWNTs are functionalized by diazonium species generated in situ from various anilines;

FIG. 2 depicts various anilines 1a-12a suitable for use in the embodiments illustrated in FIG. 1;

FIG. 3 (Scheme 2) illustrates sulfonation of aniline species used in the functionalization of SWNTs in accordance with some embodiments of the present invention;

FIG. 4 depicts a Raman spectrum of a mat (Bucky paper) of 6b;

FIG. 5 depicts a UV/vis spectrum of 6b in water;

FIG. 6 is an AFM image of 6b showing many individual functionalized single-wall carbon nanotubes;

FIG. 7 is an AFM image of 6b showing an individual nanotube section analysis;

FIGS. 8(a)-(d) depict the spectral characterization of 3b, relative to the pristine (unfunctionalized) SWNT starting material (p-SWNT), wherein absorption spectra are shown of (a) pristine p-SWNT in DMF, (b) 3b in DMF, and Raman spectra (solid, median scan of 5 different areas per sample, 633 mn excitation) are shown of (c) pristine p-SWNT and (d) 3b;

FIG. 9 is an AFM analysis (on mica) of 3b, where section analysis of an individual 140-nm-long SWNT performed at (a) a low spot and high spot, and (b) the resulting cross-sections which show heights of 8 Å and 10 Å;

FIG. 10 is an AFM-derived histogram of nanotube tube/bundle mean diameters present in a typical sample of 3b, wherein bundles begin to appear at 15 Å and over 160 structures were sampled and the results are characteristic of those obtained from the other products shown in Scheme 1, and wherein the inset figure is a TEM image of 3b suspended from a lacy carbon TEM grid (20 nm scale bar);

FIG. 11 depicts three exemplary functionalizations (A)-(C) of SWNTs in a 96% H₂SO₄+persulfate reaction medium, in accordance with embodiments of the present invention;

FIG. 12 (Scheme 3) illustrates the decomposition of a generic triazene species to a diazonium salt; and

FIG. 13 (Scheme 4) illustrates the functionalization of SWNTs with triazene species, in accordance with embodiments of the present invention.

### DETAILED DESCRIPTION OF THE INVENTION

The present invention is generally directed to methods of functionalizing (aka derivatizing) carbon nanotubes (CNTs) in acidic media. By first dispersing CNTs in an acidic medium, bundled CNTs can be separated as individual CNTs (or wherein the CNT sidewalls in the interior of a bundle are at least rendered accessible to functionalizing agents), affording exposure of the CNT sidewalls, and thereby facilitating the derivatization of such CNTs, wherein functional groups are subsequently attached to the exposed sidewalls of these individualized CNTs. Once dispersed in this substantially unbundled state, the CNTs are functionalized according to one or more of a variety of functionalization processes. Typically, ultrasonication is not needed to afford such dispersion and subsequent functionalization. Additionally, such methods are easily scalable and can provide for sidewall-functionalized CNTs in large, industrial-scale quantities.

Functionalization of CNTs can lead to improved levels of nanotube suspendability/dispersability and/or solubility in solvents. True solubility, it should be noted, is a state in which the re-aggregation of CNTs in a solvent is less favored, on a thermodynamic basis, than their continued solvated state. That said, stable suspensions can suitably permit the manipulation of CNTs for a wide range of processes. Additionally or alternatively, functionalization can be used to alter the physical and/or chemical properties of such CNTs, particularly when such functionalization involves the attachment of chemical moieties to CNT sidewalls.

Carbon nanotubes (CNTs), according to the present invention, include, but are not limited to, single-wall carbon nanotubes (SWNTs), double-wall carbon nanoutbes (DWNTs), multi-wall carbon nanotubes (MWNTs), small diameter carbon nanotubes (SDNTs), and combinations thereof Small diameter carbon nanotubes are defined herein as CNTs having diameters of at most about 3 nm. All methods of making CNTs yield product with carbonaceous impurities. Additionally, most methods of making SWNTs, and many methods of making MWNTS, use metal catalysts that remain in the product as impurities. While the examples described herein have generally been done with SWNTs, it should be understood that the methods described herein are generally applicable to all carbon nanotubes made by any known method—provided they are susceptible to the chemistries described herein by virtue of their reactivity. Furthermore, the nanotubes can be subjected to any number of post-synthesis procession steps, including cutting, length sorting, chirality sorting, purification, etc., prior to being subjected to the chemical modifications described herein.

Regarding acidic media, the acidity of aqueous acids is generally expressed by their pH, which is a logarithmic scale of the hydrogen ion concentration (or, more precisely, of the hydrogen ion activity). The pH of such an acid can be measured by the potential of a hydrogen electrode in equilibrium with a dilute acid solution or by a series of colored indicators. In highly concentrated acid solutions or with strong nonaqueous acids, the pH concept is no longer applicable, and acidity, for example, can be related to the degree of transformation of a base to its conjugate acid (keeping in mind that this will depend on the base itself). The widely used so-called Hammett acidity function Hₒ relates to the half-protonation equilibrium of suitable weak bases. The Hammett acidity function is also a logarithmic scale on which 100% sulfuric acid has a value of Hₒ −11.9. The acidity of sulfuric acid can be increased by the addition of SO₃, resulting in “fuming” sulfuric acid or oleum. The Hₒ of HF is −11.0 (however, when HF is completely anhydrous, its Hₒ is −15, but even a slight amount of water drops the acidity to −11). Perchloric acid (HClO₄; Hₒ −13.0), fluorosulfuric acid (FSO₃H; Hₒ −15.1), and trifluoromethanesulfonic acid (CF₃SO₃H; Hₒ −14. 1) are considered to be superacids, as is truly anhydrous hydrogen fluoride. Complexing with Lewis acidic metal fluorides of higher valence, such as antimony, tantalum, or niobium pentafluoride, greatly enhances the acidity of all these acids. In the 1960s, R. J. Gillespie suggested calling protic acids stronger than 100% sulfuric acid “superacids.” See Olah, J. Org. Chem., 2001, 66(18), 5943. This arbitrary but most useful definition is now generally accepted

Generally, suitable acid media include any acidic medium capable of dispersing CNTs in a substantially individualized state. In some embodiments, the acidic medium is, or comprises, an oxoacid. Examples of oxoacids include H₂SO₄, H₃PO₄, HClO₄, and HNO₃. In some embodiments, the acid medium comprises an acid selected from the group consisting of protic acids, aprotic acids, anhydrous acids, and combinations thereof In some embodiments, a superacid medium is used. The term “superacid,” as used herein, follows the definition given above. Exemplary superacid media include, but are not limited to, oleum, chlorosulfonic acid, triflic acid, fluorosulfonic acid, perchloric acid, anhydrous HF, Brönsted acid/Lewis acid complexes, and combinations thereof Brönsted acid/Lewis acid complexes include, but are not limited to, “magic acid” (HSO₃F/SbF₅), HF/SbF₅, HCl/AlCl₃, HF/BF₃, and combinations thereof.

Functionalization (derivatization), as defined herein, generally includes any type of chemical functionalization of CNTs permissible in acidic media. These functionalization protocols generally comprise a functionalizing agent suitable for attaching chemical moieties to the CNTs, and particularly to the sidewalls of CNTs. Such functionalization can comprise end functionalization and/or sidewall functionalization, wherein the former comprises the attachment of species to the CNT ends in either their capped or opened state, and the latter comprises the addition of chemical moieties to the sides of the CNTs. Numerous reviews of CNT functionalization exist (see Dyke et al., J. Phys. Chem. A, 2005, 108, 11151; Bahr et al., J. Mater. Chem., 2002, 12, 1952; Holzinger et al., Angew. Chem. Int. Ed., 2001, 40, 4002), much of which could be used in methods of the present invention.

In some embodiments, the extent of functionalization is dependent upon a number of factors, e.g., the reactivity of the CNTs, the reactivity of the functionalizing agent, steric factors, etc. In some such embodiments, as a result of such dependencies, the extent of functionalization can be in the range of from at least about 1 functional group per every 1000 CNT carbons to at most about 1 functional group per every 2 CNT carbons.

An exemplary method of functionalization used in some embodiments of the present invention involves existing diazonium functionalization protocols, save generally for the fact that a solvent change is made in providing for the reaction medium (i.e., to an acid). In such embodiments, the functionalizing agent is a diazonium species provided either from an aryl diazonium salt, or formed in situ by the reaction of a substituted aniline with sodium nitrite (or alkyl nitrite). See PCT Patent Application Publication No. WO 02/060812 A2 by Tour et al.; PCT Patent Application No. US03/22072 by Tour et al.; Bahr et al., J. Am. Chem. Soc., 2001, 123, 6536-6542; and Dyke et al., J. Am. Chem. Soc., 2003, 125, 1156-1157. Additionally, such functionalization can differ from previous diazonium functionalization methods in that such functionalization benefits from the presence of a radical source. In some embodiments of the present invention, such diazonium protocols can be carried out in an acidic medium to selectively functionalize SWNTs on the basis of their electronic type, as previously done in non-acidic media (Strano et al., Science, 2003, 301, 1519-1522). Such selective functionalization is useful in the separation and/or partitioning of SWNTs by electronic type.

Under favorable conditions, cationic intermediates may suitably behave as functionalizing agents and react with CNTs. For example, isopropanol in a superacid medium (with or without a Lewis acid) can cause an isopropyl cation to form that would then react with the pi electron-rich CNT—since the CNTs are the only nucleophilic species in solution. See M. B. Smith and J. March, March's Advanced Organic Chemistry 5^{th} Ed., Wiley-Interscience, New York: 2001, p. 1328. Likewise, cations can be generated from any alkene or alkyne. Generally, these could be viewed as Friedel-Crafts-type reactions where the CNT acts as the representative nucleophile toward an electrophilic species (Smith and March, p. 710). Candidate electrophiles include, but are not limited to, (a) carbocations such as alkyl, alkenyl, alkynyl, aryl, and acyl (RCO⁺) cations; (b) halonium ions such as Cl⁺, Br⁺, I⁺ and F⁺ species (Smith and March, pp. 446-447); (c) metal cations, specifically transition metals and group III-A through VI-A metals; and (d) other known types of species used in Friedel-Crafts reactions.

Dipolorophiles can serve as functionalizing agents to potentially functionalize CNTs in acidic media Suitable examples include, but are not limited to, the Prato dipolorophile reaction (Georgakilas et al., J. Am. Chem. Soc. 2002, 124, 760), the nitrile oxide reaction (Meier et al., Org. Chem. 1993, 58, 4524), and the use of trimethylene methane-derivatives. Also, ylides can be suitable functionalizing agents in some embodiments of the present invention.

Benzyne addition (from anthranilic acid and isoamyl nitrite) (Meier et al., J. Am. Chem. Soc. 1998, 120, 2337) or 2-(trimethylsilyl)phenyltrifluoro-methanesulfonate treated with TBAF, which has been shown to give benzyne (Himeshima et al., Chem. Lett. 1983, 1211), are suitable for functionalizing CNTs in some embodiments.

Radicals, in general, can suitably serve as functionalizing agents, in accordance with some embodiments of the present invention. Radical intermediates can be generated thermally, photochemically, or chemically using initiators or sensitizers, and this chemistry is generally compatible with superacids. Thus, any such radical source could potentially serve as a functionalizing agent. Suitable radicals include, but are not limited to, (a) carbon radicals such as alkyl, alkenyl, alkynyl, aryl, and acyl (RCO) radicals; (b) halogen radical species; (c) hetero-atom radical species such as oxy radicals; and (d) metal-based radicals, specifically transition metals and group III-A through VI-A metals.

Other suitable functionalization reactions include, but are not limited to, the following: (a) oxidation reactions, such as reaction with a species selected from the group consisting of peroxyacids; metal oxidants, such as osmium tetraoxide, potassium permanganate, chromates; ozone; oxone; oxygen; superoxides; and combinations thereof; (b) reaction with reductants such electrochemical reductants or other species that are superacid-compatible; (c) reaction with heteroatomic nucleophiles, where the nucleophile bears a lone pair of electrons such as sulfides or thiols; (d) reaction with carbenes; and (e) reaction with dienes that could react with the tubes such that the tubes act as a dieneophile in a Diels-Alder reaction.

While the making and/or using of various specific embodiments of the present invention are discussed below, it should be appreciated that the present invention provides many applicable inventive concepts that may be embodied in a variety of specific contexts. The specific embodiments discussed herein are merely illustrative of specific ways to make and/or use the invention and do not delimit the scope of the invention.

As mentioned above, in some embodiments the present invention is directed to processes that exploit the solubility of CNTs in superacid media (e.g., oleum=filming sulfuric acid=H₂SO₄+SO₃) to covalently attach functional groups to the sidewalls of CNTs. This affords individual functionalized CNTs that are dispersible in a variety of matrices. Such solubility of CNTs in superacid media is described in PCT Patent Application Publication No. WO 01/30694 A1 by Smalley et al., United States Patent Application Publication No. US 2003/0170166 A1 by Smalley et al.; and in Davis et al., Macromolecules, 2004, 37, 154. Such materials are likely to provide optimal properties in many potential materials applications.

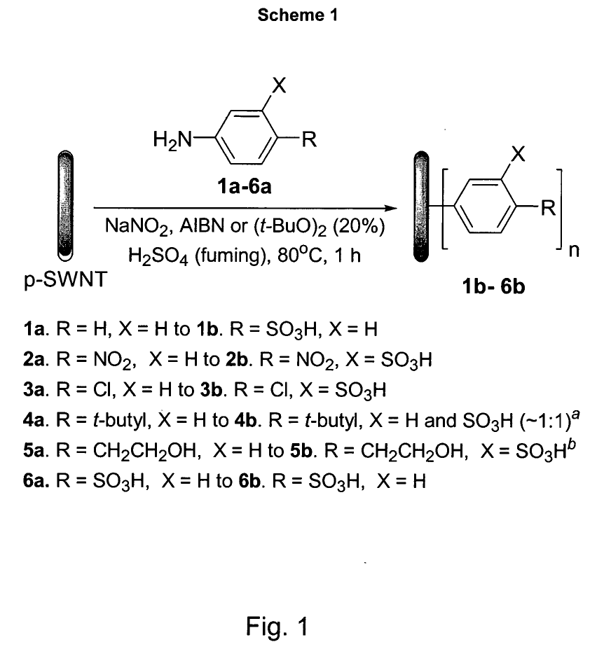

In some embodiments, the present invention is directed to methods (processes) involving the following steps: (a) dispersing oxidatively-treated SWNTs with stirring in oleum to form a dispersion/solution; (b) filtering the dispersion/solution over glass wool to remove any impurities; (c) adding an aniline of choice to form a reaction mixture; (d) cautiously adding sodium nitrite (or other suitable nitrite species), followed by a radical source, to the reaction mixture; and (e) heating and stirring the mixture for one hour; diluting the mixture with water, after which it is filtered and washed with acetone. The resultant solid (functionalized SWNTs) can then be suspended in water and filtered again to remove impurities. Such embodiments are illustrated in Scheme 1 (FIG. 1), wherein compounds 1a-6a are anilines used to form functionalized SWNTs 1b-6b.

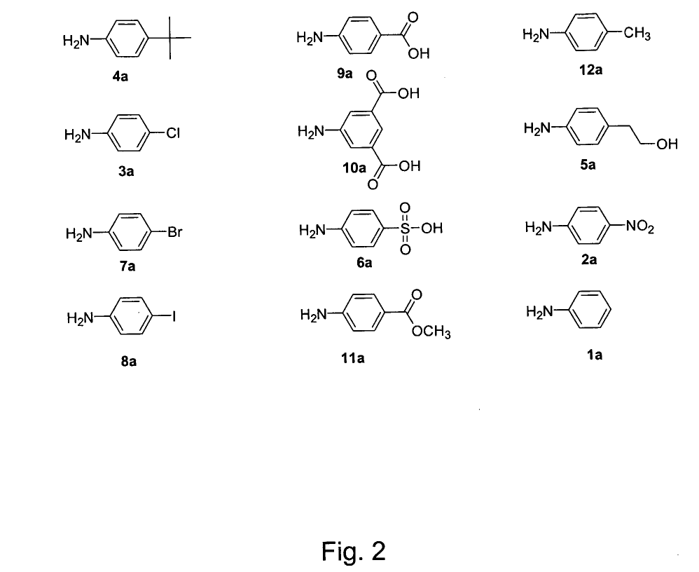

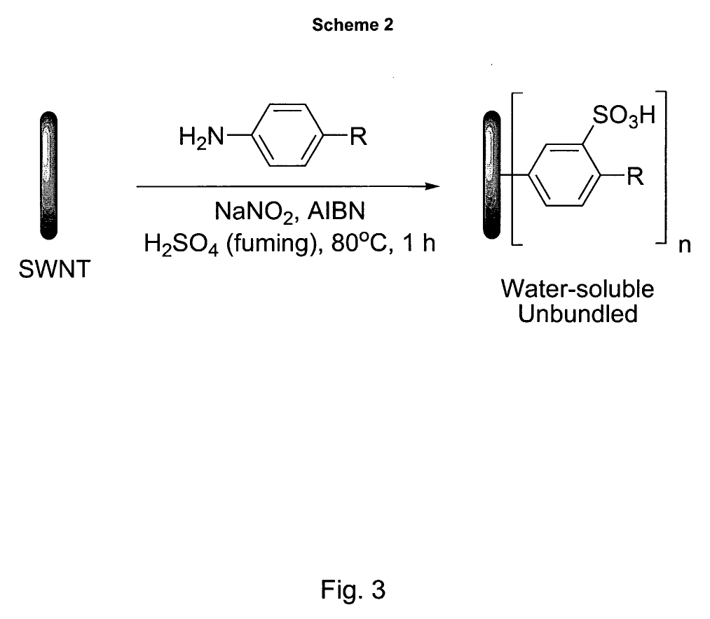

Suitable aniline species for use in the above-described embodiments are shown in FIG. 2, compounds 1a-12a. In some such embodiments, sulfonation of the aniline occurs, as shown in FIG. 3 for the case of 1a. The products in such cases are water soluble. Of those anilines shown in FIG. 2, only those that are very electron deficient (e.g., 2a, 6a, and 10a) will prevent further electrophilic aromatic substitution.

Numerous variations on the above-described embodiment exist and should be considered as alternative embodiments of the present invention. For example, such processes are applicable to other carbon nanotubes such as multi-wall carbon nanotubes (as mentioned above). The superacid used in the above-described embodiment is oleum, but the process is by no means limited to this medium. Sulfanilic acid is an exemplary aniline, but any aniline is a possible variation (see FIG. 2). Under the conditions described above, using sulfanilic acid or dicarboxylic acid anilines (i.e., 10a) or other anilines that might sulfonate (see FIG. 3) during the course of the functionalization, water soluble nanotubes are yielded. Note that sulfonation is generally reversible through the addition of acidic water (e.g., 70% sulfuric acid) and heat. See Lauer, U.S. Pat. No. 2,022,889. While 2,2′-azo-bis-isobutyrylnitrile (AIBN) is an exemplary radical source, any substance that is known to break down into radicals at relatively low temperatures may be used as a substitute (e.g., benzoyl peroxide and di-tert-butylperoxide). The addition of radical source may not be essential, but it is generally advantageous. It may be that only small amounts of superacid are needed, such as enough superacid sufficient to merely make a paste of the mixture, i.e., following the protocol of Applicants' previously disclosed solvent-free (solvent-wetted) disclosures. See PCT Patent Application No. US03/22072, filed Jul. 15, 2003, by Tour et al. Thus, the concentration of the reaction can vary widely from fractions of a milligram of nanotubes per mL of superacid to paste-like conditions wherein the mechanical action of a stirring system on the superacid-wetted tubes results in exfoliation and reaction of individual nanotubes with the reactant. For a complete description of solvent-wetted reactions or paste-like conditions, see Dyke et al., J. Am. Chem. Soc., 2003, 125, 1156.

While the processes disclosed here typically use heat, room temperature processes are also effective on these and other anilines. Note that anilines used sucessfully to date include aniline (1a) (aminobenzene, which sulfonates under the same reaction conditions), 4-nitroaniline (2a), 4-chloroaniline (3a), 4-tert-butylaniline (4a), 4-(2-hydroxyethyl)aniline (5a), sulfanilic acid (6a), 4-bromoaniline (7a), 4-iodoaniline (8a), 4-aminobenzoic acid (9a), isophthalic acid (10a), methyl 4-hydroxybenzoate (11a), and 4-toluidine (12a) (see FIG. 2). This demonstrates the generality of such processes.

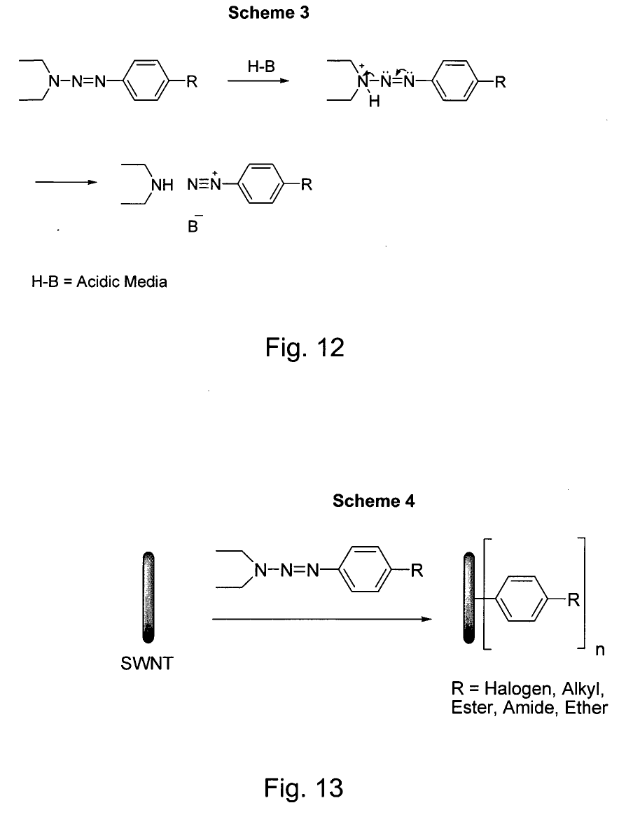

In some embodiments, pre-formed diazonium salts are used instead of, or in addition to, the aniline/nitrite (alkyl nitrite or sodium nitrite) combinations described above. In some or other embodiments, decomposition of triazene species are used to generate diazonium species. Regarding these latter embodiments, triazenes are known to decompose to form diazonium salts in an acidic medium (Bräse et al., Acc. Chem. Res., 2004, 37, 805-816). This decomposition occurs by protonation of the triazene followed by spontaneous formation of the diazonium salt and the leaving of the corresponding amine, as shown in Scheme 3 (FIG. 12). Reaction of such triazene species with CNTs (e.g., SWNTs) is shown in Scheme 4 (FIG. 13).

In addition to the diazonium reactions described above, the processes described herein should be general to a host of organic and organometallic reactions, provided that the reagents are sufficiently reactive in the superacid medium for a time sufficiently long for the reaction to take place.

Although the CNTs used here were oxidatively-treated in an effort to purify the sample prior to functionalization, this protocol can also be used on the crude, as provided, CNTs. Additionally, the scope of the present invention generally extends to inorganic carbon materials other than carbon nanotubes. Such carbon materials include, but are not limited to, fullerenes, graphitic carbon, carbon black, acetylenic carbon, diamond, vapor grown carbon fibers, and combinations thereof Note, however, that the action of some oxoacids (e.g., oleum) on some of these carbon materials may be sufficiently oxidative (to the carbon material) so as to preclude such a combination.

In some embodiments, the present invention is directed to processes carried out in acidic media not falling within the definition of superacids. As an example, in some embodiments, functionalization is carried out in non-fuming sulfuric acid mixtures (e.g., 96% H₂SO₄). Typically, in such embodiments, a persulfate species (e.g., K₂S₂O₈ or (NH₄)₂S₂O₈) is added to the sulfuric acid.

It is widely accepted that individual carbon nanotubes are necessary to achieve optimum properties in many potential applications. To date, however, no process exists to reliably produce individual carbon nanotubes on a bulk scale. The present invention provides for the production of individual, functionalized CNTs by a process that is highly scaleable, and it does so without the need for fluorine, sonication, surfactant-wrapping, and centrifugation—which previous methods for generating individual carbon nanotubes have relied upon. Fluorine use, sonication and centrifugation are frowned upon heavily by industry due to the difficulty in scaling these processes. As a result, existing prior art methods could never be scaled to provide a process that affords individualized nanotubes in the quantities needed for materials applications in bulk. On the other hand, industry is well versed in the use of sulfuric acid (Kevlar® is commercially processed in 96% sulfuric acid), allowing methods of the present invention to be easily scaled.

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### EXAMPLE 1

This Example serves to illustrate the functionalization of SWNTs in oleum via diazonium species generated in situ from 6a (FIG. 1), and the characterization of such functionalized species, in accordance with embodiments of the present invention.

Purified single wall carbon nanotubes (0.050 g, 4.2 mmol), (purified according to Chiang et al., J. Phys. Chem. B 2001, 105, 8297) were dispersed in oleum (50 mL, 20% free SO₃) at 80° C. This dispersion was then filtered over glass wool to remove any large particulates. Sulfanilic acid (6a, 2.91 g, 16.8 mmol) was added to the dispersion followed by sodium nitrite (1.16 g, 16.8 mmol). Finally 2,2′-azo-bis-isobutyrylnitrile (AIBN, 1.38 g, 8.4 mmol) was added to provide a radical source. This solution was allowed to stir at 80° C. for one hour at which point the reaction mixture was poured into 300 ml of water. This mixture was then filtered over a polycarbonate membrane filter (1 μm pore size), and washed with 500 mL of acetone. The resultant black powder product, 6b, was then dispersed in water and filtered to be certain any soluble impurities were removed. At this point, product 6b was ready for use and/or characterization.

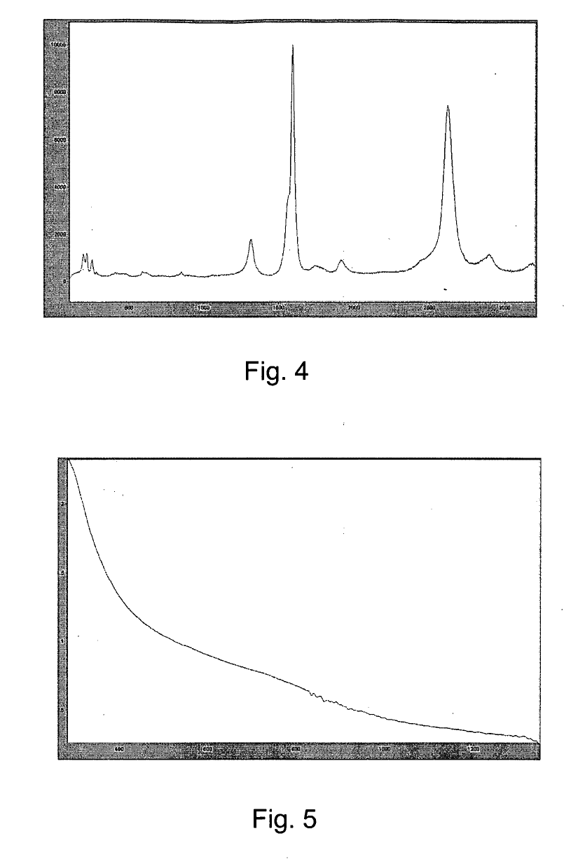

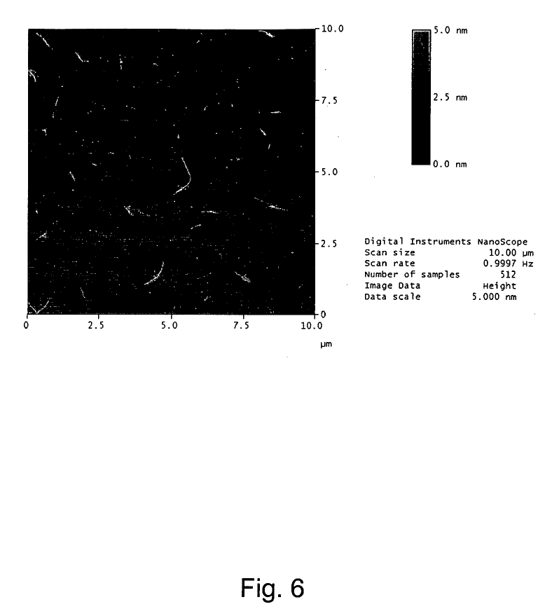

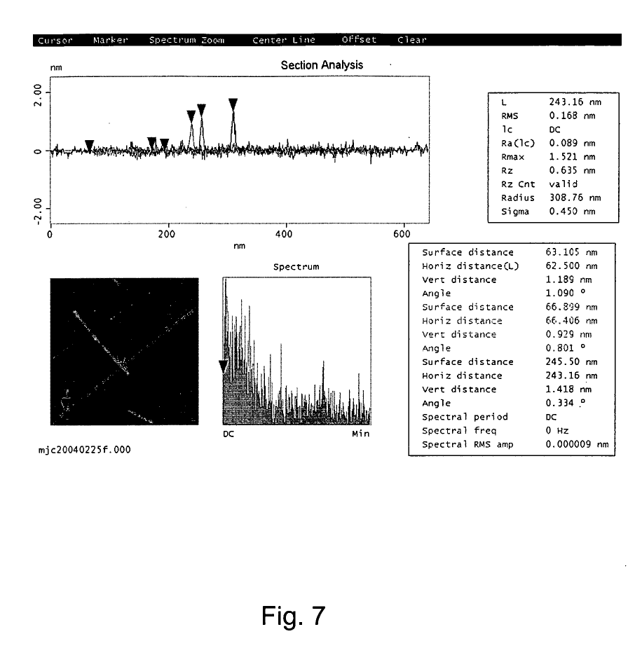

Note the Raman spectrum (FIG. 4) and the UV/vis spectrum (FIG. 5) of 6b where the transitions are clear that functionalization has occurred. Most importantly, however, notice the atomic force microscopy (AFM) image (FIG. 6) and corresponding section analysis (FIG. 7) of 6b where many single tubes are formed and they do not tend to re-rope. This material was not centrifuged prior to imaging, and there is no surfactant present. For a description of the spectral characterization utilization, see J. L. Bahr et al., J. Mater. Chem. 2002, 12, 1952-1958. And, as a comparison, for non-bundling tubes generated by surfactant wrapping followed by functionalization, see Dyke et al., Nano Lett. 2003, 3, 1215-1218; and Dyke et al., Chem. Eur. J. 2004, 10, 812-817.

Interestingly, and significantly, when sulfanilic acid was used as described, stable water suspensions of the functionalized nanotubes could be generated The suspensions did not settle even after one week.

### EXAMPLE 2

This Example serves to illustrate the functionalization of SWNTs in oleum via diazonium species generated in situ from 3a (FIG. 1), and the characterization of such functionalized species, in accordance with embodiments of the present invention.

Purified-SWNTs (p-SWNT, 50 mg, 4.2 milliequiv. of carbon) were dispersed in oleum (50 mL, 20% free SO₃, Aldrich) with magnetic stirring (3 hours). Sodium nitrite (1.16 g, 16.8 mmol) was added followed by 4-chloroaniline (3a) (2.14 g, 16.8 mmol) and azobisisobutyronitrile (AIBN) (0.14 g, 0.84 mmol) (AIBN and di-tert-butylperoxide produced similar results; however, degrees of arylation were about 50% greater using AIBN). The reaction was stirred at 80° C. for 1 hour, then carefully poured into water and the suspension filtered through a polycarbonate membrane (1 μm). The filter cake was washed with water and acetone, and then dried (55 mg of 3b). The solid (3b) could be dispersed as individuals (unroped) in a variety of solvents including water, N,N-dimethylformamide (DMF), and ethanol (0.24, 0.16, and 0.06 mg/mL, respectively) using a dissolution/filtration protocol outlined previously (see Dyke et al., Chem. Eur. J., 2004, 10, 812). Scales as large as 1.5 g of p-SWNTs in 500 mL of oleum yielding 2.0 g of functionalized tubes have been executed with similar results. Higher concentrations can be used; however, mechanical stirring may be needed due to the resultant high viscosity solutions. Several controls were also carried out on the above-described conditions: (a) without AIBN, (b) without aniline and (c) without nitrite, AIBN and aniline. Under all of the control conditions, no sidewall functionalization was observed by Raman spectroscopy (no D-band increase, vide infra).

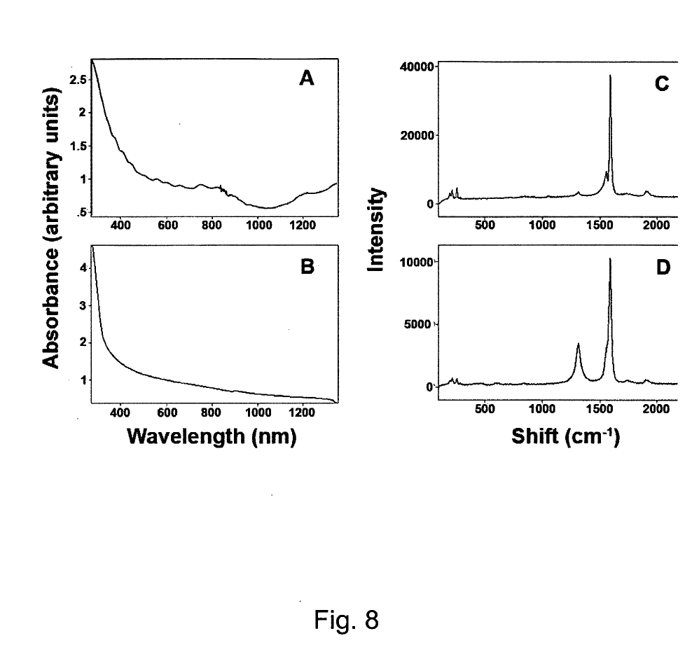

FIG. 8(a), shows the characteristic van Hove singularities of the unfunctionalized p-SWNT starting material. FIG. 8(b) shows the loss of these transitions in product 3b, which is confirmation of covalent functionalization, and this was characteristic of all the products obtained (1b-6b). Likewise, in FIG. 8(c), the Raman spectrum of the starting p-SWNT shows a very small disorder mode (D-band) at 1290 cm⁻¹. In FIG. 8(d), the spectrum of the functionalized material, there is a significant increase in the disorder mode relative to the large tangential mode (G-band), consistent with a high degree of functionalization. Similarly, the Raman resonance enhancement seen in FIG. 8(c) is suppressed after functionalization, consistent with covalent attachment.

Thermogravimetric analysis (TGA) of 3b (Ar, 10° C./minute to 800° C.) showed a weight loss of 22% which corresponds to approximately 1 functional group per 30 nanotube carbons. Although sulfonated aromatic pyrolysates can be carbonaceous, thereby complicating the TGA data, Raman D to G-band intensities are similar to known material of that degree of functionalization.

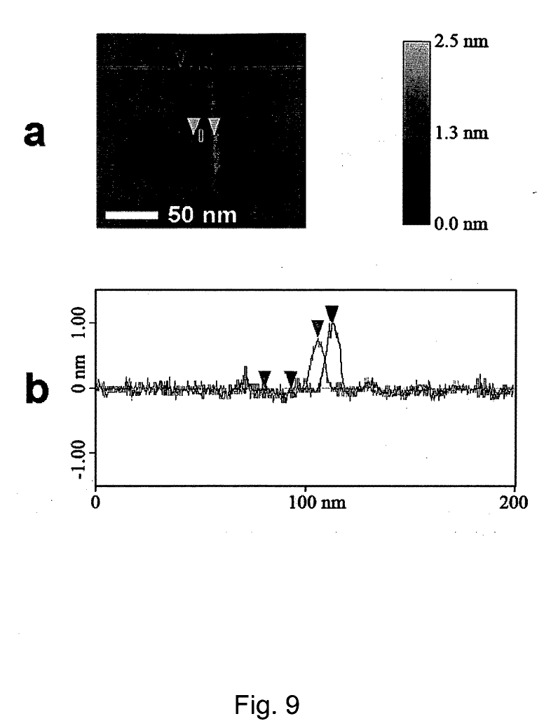

The presence of individual SWNTs was confirmed via atomic force microscopy (AFM). Height data was used to assess tube diameters for numerous experimental products and controls. FIG. 9(a) is an image of an individual SWNT sample of 3b imaged on a mica surface, wherein section analysis of an individual 140-nm-long SWNT was performed at (a) a low spot and high spot, and (b) the resulting cross-sections which show heights of 8 Å and 10 Å. The height, and thus diameter, of the tube ranges from 7-10 Å, with a mean diameter of 8 Å; this is consistent with the diameters of typical HiPco-produced tubes (Weisman et al., Appl. Phys. A: Mater. Sci. Process, 2004, 78, 1111), but with small perturbations due to addend-based surface roughening (Dresselhaus et al., Science of Fullerenes and Carbon Nanotubes; Academic Press, San Diego, 1996).

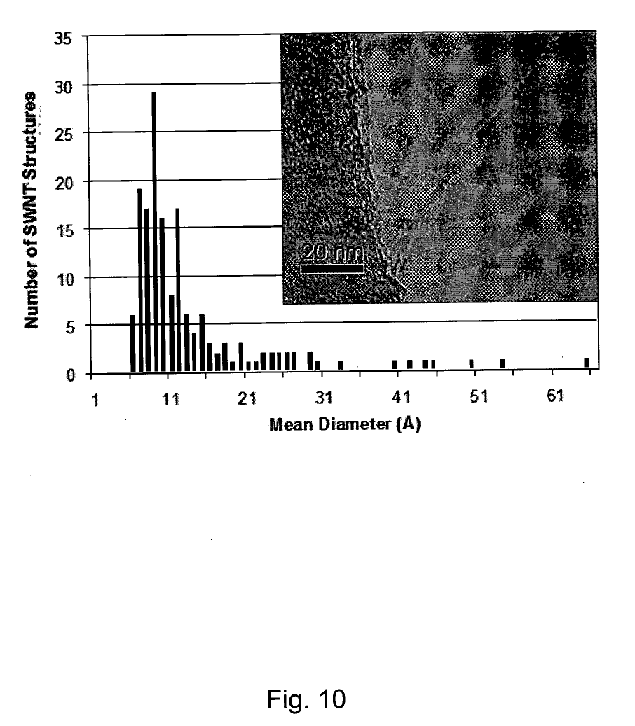

Individual SWNTs were the dominant feature in over 90% of the cases, but small bundles, typically 2-3 nm in diameter, were also observed, as shown in FIG. 10. FIG. 10 is a AFM-derived histogram of nanotube tube/bundle mean diameters present in a typical sample of 3b. Bundles begin to appear at 15 Å. Over 160 structures were sampled and the results are characteristic of those obtained from the other products shown in Scheme 1. The nanotubes were generally short, exhibiting a mean length of 100 nm. Note that the initial nanotube lengths (i.e., prior to functionalization) could not be obtained due to their existence as bundled roped structures.

Finally, transmission electron microscopy (TEM) of 3b, suspended from a lacy carbon TEM grid, revealed the presence of unbundled (throughout their entire length) surface roughened (due to the aryl addends) functionalized SWNTs, as shown in FIG. 10 (inset).

### EXAMPLE 3

This example illustrates functionalization of SWNTs with diazonium species in 96% sulfuric acid using persulfates, in accordance with embodiments of the present invention.

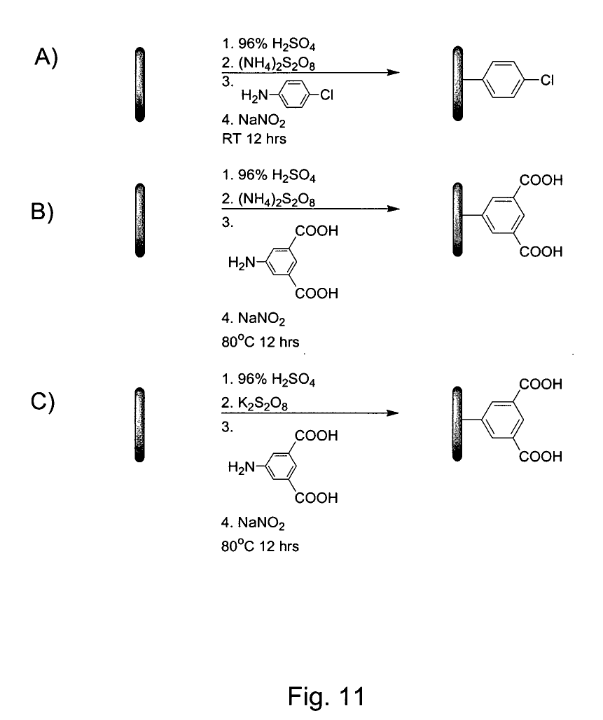

SWNTs (10 mg) are added to a round-bottom flask and 96% sulfuric acid (30 mL), along with the persulfate (ammonium or potassium, 1.3 equiv. to water in 96% H₂SO₄), is added. The solution is homogenized until the solution becomes black. Homogenization is done using a modular system with a shaft and generator assembly powered by a rotating motor (Dremel®). The shaft and generator assembly are introduced into the solution and the motor spins the assembly at ˜5000 rpm causing shear in the solution and effectively dispersing the SWNTs. Then, an aniline derivative is added (2 equiv.) followed immediately by sodium nitrite (2 equiv.). The solution is then homogenized either at room temperature (RT) or 80° C. for 1-12 hours. Workup is done by pouring the resulting solution/suspension over ice and filtering. Exemplary such reactions are shown in FIG. 11, reactions (A)-(C).

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

1. A method comprising the steps of:
a) dispersing carbon nanotubes in an acidic medium to form dispersed carbon nanotubes with substantially exposed sidewalls; and
b) functionalizing the dispersed carbon nanotubes by covalently attaching functional groups to their substantially exposed sidewalls to yield sidewall functionalized carbon nanotubes.

2. The method of claim 1, wherein the carbon nanotubes are selected from the group consisting of single-wall carbon nanotubes, double-wall carbon nanotubes, multi-wall carbon nanotubes, small diameter carbon nanotubes, and combinations thereof.

3. The method of claim 1, wherein the acid medium comprises a superacid.

4. The method of claim 1, wherein the acid medium comprises an oxoacid selected from the group consisting of H₂SO₄, H₃PO₄, HClO₄, and HNO₃, and combinations thereof.

5. The method of claim 1, wherein the acid medium comprises H₂SO₄.

6. The method of claim 1, wherein the acid medium comprises a persulfate species.

7. The method of claim 1, wherein the step of functionalizing involves a functionalizing agent selected from the group consisting of carbocations, halonium ions, metal cations, carbon radicals, halogen radicals, hetero-atom radical species, metal-based radicals, dipolarophiles, and combinations thereof.

8. The method of claim 1, wherein the step of functionalizing involves a diazonium species.

9. The method of claim 8, wherein the diazonium species is generated in situ by reaction of an aniline species with a nitrite species.

10. The method of claim 8, wherein the diazonium species is provided as a diazonium salt.

11. The method of claim 8, wherein the diazonium species is generated from a triazene precursor.

12. The method of claim 1 further comprising at least one post-processing step selected from the group consisting of diluting, filtering, washing, drying, and combinations thereof.

13. The method of claim 1 further comprising the steps of:
a) isolating the sidewall functionalized carbon nanotubes from the acidic medium by filtering to yield isolated sidewall functionalized carbon nanotubes; and
b) resuspending the isolated sidewall functionalized carbon nanotubes in a solvent.

14. The method of claim 13, wherein the solvent is water.

15. The method of claim 1, wherein the functionalized carbon nanotubes have at least about 1 functional group per every 100 carbon nanotube carbons.

16. A method comprising the steps of:
a) dispersing single-wall carbon nanotubes in a superacid medium to form a dispersion;
b) adding aniline species and a nitrite species to the dispersion to form a reaction mixture; and
c) reacting the reaction mixture to form functionalized single-wall carbon nanotubes.

17. The method of claim 16, wherein the single-wall carbon nanotubes have been oxidatively treated.

18. The method of claim 16, wherein the single-wall carbon nanotubes are homogeneous in a characteristic selected from the group consisting of length, diameter, chirality, and combinations thereof.

19. The method of claim 16 further comprising a step of filtering the dispersion to remove any large particles.

20. The method of claim 16, wherein the superacid medium is selected from the group consisting of oleum, chlorosulfonic acid, triflic acid, and combinations thereof.

21. The method of claim 16, wherein the aniline species comprises sulfanilic acid.

22. The method of claim 16 further comprising a step of adding a radical source to the reaction mixture.

23. The method of claim 22, wherein the radical source is selected from the group consisting of 2,2′-azo-bis-isobutyrylnitrile, benzoyl peroxide, di-tert-butylperoxide, and combinations thereof.

24. The method of claim 16, wherein the step of reacting comprises heating and stirring.

25. The method of claim 16 further comprising the steps of:
a) diluting the reaction mixture with water, subsequent to forming functionalized single-wall carbon nanotubes, to form a diluted reaction product mixture;
b) filtering the diluted reaction product mixture over a filter to isolate the functionalized single-wall carbon nanotubes; and
c) washing the isolated functionalized single-wall carbon nanotubes with a washing solvent to obtain washed functionalized single-wall carbon nanotubes.

26. The method of claim 25, wherein the washing solvent is acetone.

27. The method of claim 25 further comprising the steps of:
a) re-suspending the washed functionalized single-wall carbon nanotubes in water to form a re-suspension;
b) filtering the re-suspension to recover re-washed functionalized single-wall carbon nanotubes.

28. The method of claim 16, wherein the functionalized single-wall carbon nanotubes have at least about 1 functional group per every 100 carbon nanotube carbons.
